(19) United States
(12) Patent Application Publication
(10) Pub. No.: US 2012/0209824 A1
(43) Pub. Date: Aug. 16, 2012

(54) APPARATUS, METHOD, AND STORAGE MEDIUM STORING PROGRAM FOR PROCESSING INFORMATION

(75) Inventor: Kazunobu MORIMOTO, Kawasaki (JP)

(73) Assignee: FUJITSU LIMITED, Kawasaki-shi (JP)

(21) Appl. No.: 13/325,637

(22) Filed: Dec. 14, 2011

(30) Foreign Application Priority Data
Feb. 10, 2011 (JP) 2011-027593

(51) Int. Cl. G06F 17/30

(52) U.S. Cl. 707/705; 707/E17.005

(57) ABSTRACT

An information processing apparatus includes a unit to receive designation of a plurality of information acquiring targets; a unit generating second discrimination information on a basis of a plurality of pieces of first discrimination information that respectively discriminate the plurality of designated information acquiring targets; a storing unit storing a relation between the first discrimination information and the second discrimination information; and an outputting unit to output the second discrimination information.

### CROSS-REFERENCE TO RELATED APPLICATIONS

This application is based upon and claims the benefit of priority of the prior Japanese Patent Application No. JP2011-027593, filed on Feb. 10, 2011, the entire contents of which are incorporated herein by reference.

### FIELD

The present invention relates to an information processing technique.

### BACKGROUND

Up to now, techniques of supporting the provision of a product or service to users on Websites or other media on the Internet have been proposed. On such Websites, for example, a user selects a product that he/she wishes to purchase or a service that he/she wishes to receive, and saves the selected product or service in a virtual cart. Hereinafter, the reception of a service refers to the purchase of a service. On such a Website, the user may purchase a plurality of products or a custom-made product including a plurality of constituents. The user may also purchase a plurality of services or a custom-made service including a plurality of constituents.

Then, on such a Website, the user can select and purchase the product(s) or service(s) as described above while browsing across multiple Web pages within the Website. Hereinafter, the Website refers to a system including one or more Web pages. In addition, the Web page refers to information provided on the Website or a screen included in the Website.

Furthermore, various construction supporting systems have been proposed so that a user who does not have much product knowledge can easily construct a complicated product, for example, a custom-made model.

Patent document 1: Japanese Patent Laid-Open No. 2004-259226
Patent document 2: Japanese Patent Laid-Open No. 10-124422

### SUMMARY

In the case of a product whose components (constituents) can be freely selected, such as a custom-made model product, the number of configuration patterns thereof is extremely large. Though the product is made up using a construction supporting system, some troubles occur when the user intends to inform someone of the product or display the product on a Web page. For example, it is troublesome to tell the model number or name of each component one by one in order to inform someone of the custom-made product.

Furthermore, in the case of face-to-face sales such as in-store sales, a customer can actually see and touch a product. In contrast, in the case of a Website such as a shopping site, a customer who has accessed the Website needs to take the trouble of selecting components in order to see the same product, and this places a burden on the customer.

In addition, on the Web, it is desirable that a search target (for example, a product) be displayed by one common URL such that the search target is effectively searched by search engines or introduction of the search target is accomplished by a link placed on another Web page or blog (Weblog). Unfortunately, in general, a Web page for a custom-made product is dynamically created. For this reason, dynamic parameters for identifying components of the product may be given to a Web server that creates the Web page in some cases. The dynamic parameter herein refers to a parameter for designating information that changes with a product configuration as in a custom-made case. The Web page corresponding to the product configuration, which is created by such dynamic parameters, cannot be easily represented by one URL. For example, the following techniques can be conceived as a technique of representing the Web page corresponding to the product configuration by one URL.

A first technique involves configuration of the URL such that the URL includes information of the product configuration with regard to a given product whose product configuration has been selected, in order to display a product having the same product configuration with the same URL.

According to this technique, a problem would not occur when the length of the URL is not restricted. Unfortunately, a long URL is restricted in many cases by a browser or Web server from the point of view of security and other troubles. Meanwhile, because a custom-made product is made up by a large number of components, the URL tends to be long. As a result, this technique cannot create the URL that designates the Web page of the product, leading to associated problems. Accordingly, this technique cannot readily notify someone of the configuration of a product or service.

A second technique involves saving a selected product configuration in a shopping site and issuing an ID for identifying the saved product configuration for this product configuration, such that the URL includes the ID.

Unfortunately, according to this technique, different IDs are expected to be issued for products having the same configuration created by a plurality of users. When the different IDs are issued for the products having the same configuration, different URLs are issued correspondingly to the respective IDs. That is, with regard to the assembly of Web pages created by the plurality of users, the Web page on the products having the same configuration cannot be represented by one URL. A further specific problem that is caused by the fact that the Web page of the product having the same configuration cannot be represented by one URL is as follows.

For example, it is known that a URL that has been introduced on a Web page is collected as a search result target of a search engine. In the case, as described above, where the plurality of Web pages exist for the products having the same configuration, URL evaluation by the search engine is separately performed for each Web page. As a result of the evaluation for each Web page, even a product actually having a high rating of evaluation may be underestimated erroneously. Accordingly, this technique cannot adequately notify someone of the intrinsic evaluation and value of a product or service.

An aspect of the disclosed technique can be exemplified by the following information processing apparatus. The information processing apparatus includes a unit to receive designation of a plurality of information acquiring targets; a unit to generate second discrimination information on a basis of a plurality of pieces of first discrimination information that respectively discriminate the plurality of designated information acquiring targets; a storing unit to store a relation between the first discrimination information and the second discrimination information; and an outputting unit to output the second discrimination information.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is an example configuration block diagram illustrating a shopping site system according to an embodiment;

FIG. 2 is a schematic illustration of a Web server system and a database;

FIG. 3 is an example block diagram illustrating a hardware configuration of a Web server;

FIG. 4 is a process flowchart for constructing a computer of a custom-made model;

FIG. 5 is a schematic illustration of an example product selecting page;

FIG. 6 is a schematic illustration of an example model name database;

FIG. 7A is a schematic illustration of an example configuration information table;

FIG. 7B is a schematic illustration of an example character string table;

FIG. 8 is a schematic illustration of an example of a generated character string and a URL corresponding to the character string;

FIG. 9 is a process flowchart for displaying a Web page of a product whose configuration has been constructed;

FIG. 10 is a schematic illustration of a search result page;

FIG. 11 is a schematic illustration of a shopping cart screen (purchase screen); and

FIG. 12 is a schematic illustration of an example e-mail message for delivering a URL.

### DESCRIPTION OF EMBODIMENT(S)

One aspect of an embodiment has an object to improve the convenience of transmitting information related to a plurality of information acquiring targets such as a product or service including a plurality of constituents.

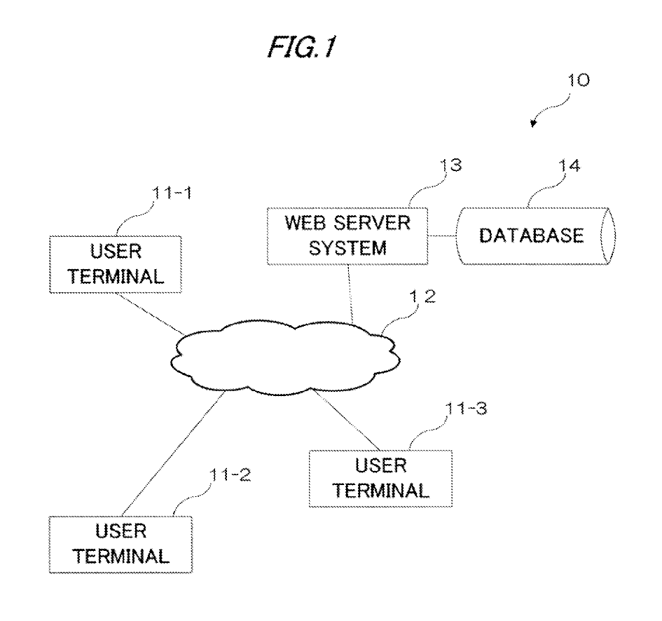

Hereinafter, an embodiment according to an aspect of the disclosed technique is described with reference to the drawings. FIG. 1 is a configuration block diagram illustrating a configuration of a Website system 10 according to the embodiment. The Website system 10 includes a plurality of user terminals 11-1 to 11-3 and a Web server system 13 that provides a service such as a shopping site to the user terminals 11-1 to 11-3. The user terminals 11-1 to 11-3 can be connected to the Web server system 13 via an Internet 12 to utilize a function of the shopping site. Note that, the user terminals 11-1 to 11-3 may be connected to the Web server system 13 via a local area network (LAN), a virtual private network (VPN), or any other network. That is, the user terminals 11-1 to 11-3 may be connected thereto via an in-house network of a company, school, government office, or any other organization, instead of the public telecommunications network.

The Web server system 13 can be connected to a database 14. The Web server system 13 and the database 14 can be connected to each other in any manner. The Web server system 13 and the database 14 may be connected to each other via, for example, a LAN. Alternatively, the database 14 may be included in and connected to the Web server system 13 via a bus. Instead, the Web server system 13 and the database 14 may be connected to each other via, for example, the Internet 12 or a VPN.

Here, an example of the user terminals 11-1 to 11-3 is a personal computer. Specifically, the user terminals 11-1 to 11-3 each include a personal computer main body including an MPU (also referred to as a CPU), a ROM, a RAM, and a communication interface; and peripheral devices, for example. Examples of the peripheral device include input devices such as a keyboard and a mouse that are connected to the computer main body, for inputting various types of information; a display device for displaying various types of information; and a printer device that prints and outputs various types of information as needed.

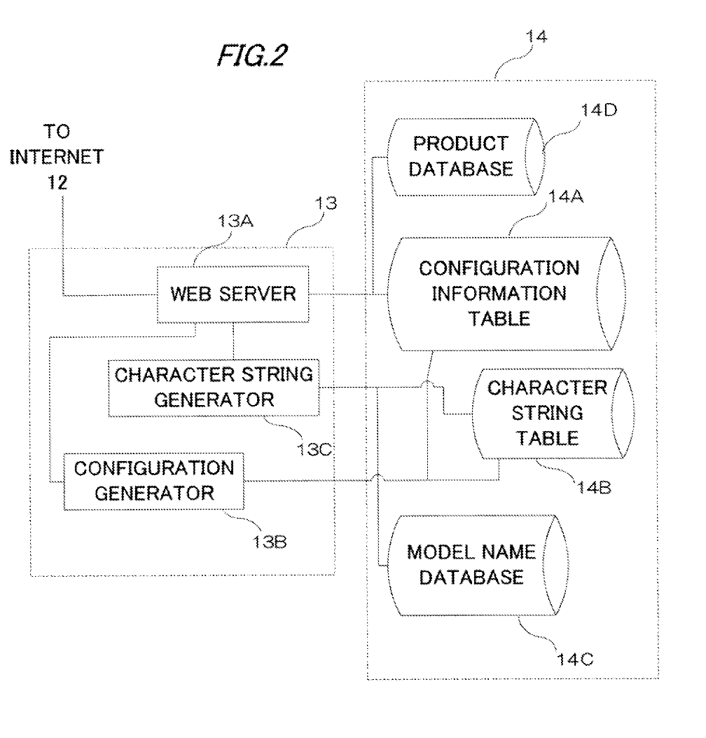

FIG. 2 is an example configuration explanatory diagram illustrating the Web server system 13 and the database 14. The Web server system 13 includes a Web server 13A, a configuration generator 13B, and a character string generator 13C. The respective constituents of the Web server system 13 are operated by, for example, the computer executing a computer program. The Web server 13A provides a Web page such as a shopping site to the user terminals 11-1 to 11-3 on the Internet 12 to implement a Web server function. The Web server 13A corresponds to an example of information processing apparatus.

When a user selects, for example, a component included in a product on the Web page such as a shopping site, the character string generator 13C generates a character string on the basis of configuration information indicating the component selected by the user. This character string reflects information of the character string designating the component of the product, and is as unique as possible. Besides, in the present embodiment, a unique ID is given to this character string through the processing of the Web server system 13, for example, in the shopping site. Note that, in the present embodiment, this character string is used for a URL having a predetermined length or smaller.

Furthermore, the character string generator 13C stores, into the database 14, the relation between the generated character string and the configuration information (a model number and other elements) indicating the component which is the origin of the character string. In the present embodiment, the relation between the configuration information designating the component and the unique ID is stored. Accordingly, the ID is given to the character string generated on the basis of the configuration information indicating the component, and the relation between the ID and each piece of configuration information is stored. When the character string can be identified, the ID corresponding to the character string is acquired, and the configuration information corresponding to the ID can be acquired.

The configuration generator 13B refers to the database 14 on the basis of a character string in a URL or a character string that is inputted by a user to a form on the Website such as the shopping site to extract an ID associated with the character string. Furthermore, the configuration generator 13B acquires configuration information corresponding to the extracted ID. The Web server 13A acquires the configuration information from the configuration generator 13B, and acquires information of each component indicated by the configuration information. Then, the Web server 13A provides the information related to the component to the user terminals 11-1 to 11-3. Note that, the configuration generator 13B may acquire the information of each component and give the information to a Web page providing program on the Web server 13A. Hereinafter, the Web server 13A refers to a function of providing a Web page onto the Internet 12, such as a Web page providing program, besides a computer itself as hardware of the Web server 13A.

The database 14 includes a configuration information table 14A, a character string table 14B, a model name database 14C, and a product database 14D. The configuration information table 14A stores the ID and one or more pieces of configuration information in association with each other. In addition, the character string table 14B stores a character string and the ID in one-to-one association with each other. The model name database 14C is a table for correlating a user interface item selected by a user, for example, a radio button on the Website such as a shopping site, with configuration information (a model number and other elements) of a component selected by the radio button. In addition, the product database 14D stores the detailed information of a component of a product, for example, specifications such as the performance, dimensions, weight, color, and material of the component, the price, and picture data showing the appearance of the component. With the database 14 thus configured, one or more pieces of configuration information are associated with a character string for one URL, and a Web page designated by one URL is created.

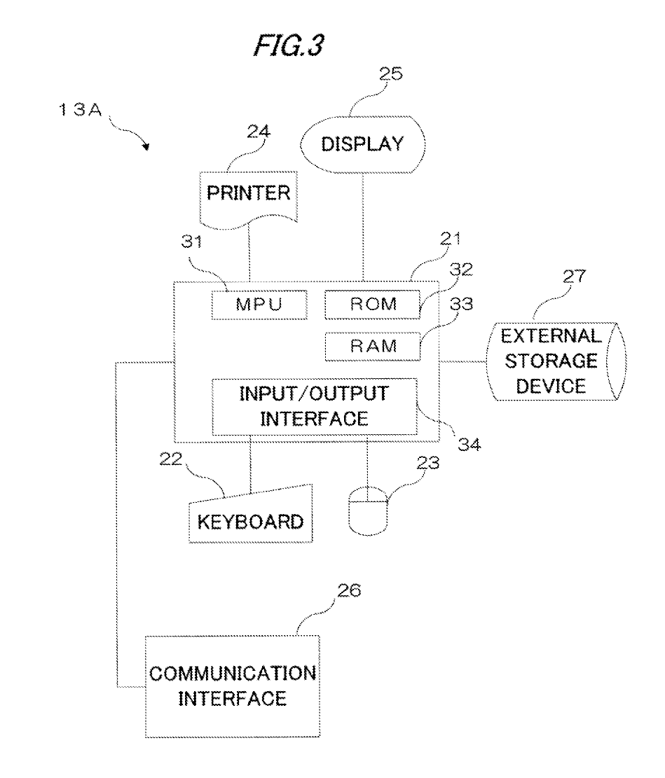

FIG. 3 is an example block diagram illustrating a hardware configuration of the Web server 13A. The Web server 13A includes a controller 21 that controls the Web server 13A; a keyboard 22 connected to the controller 21, for inputting various types of information; and a mouse 23 connected to the controller 21, for inputting various types of information. Note that another input device, for example, a touch panel may be used instead of the keyboard 22 and the mouse 23.

The Web server 13A further includes a printer 24 that prints various types of information; and a display 25 that displays various types of information. The Web server 13A further includes a communication interface 26 that functions as an interface at the time of communication via a communication network such as the Internet 12; and an external storage device 27 that is exemplified by a hard disk drive and can store high-capacity data. Note that the Web server 13A may also include an input/output device for removable storage media such as a flash memory card, a compact disc (CD), a digital versatile disk (DVD), and a Blu-ray disc, in addition to the external storage device 27.

The controller 21 is also referred to as a control unit. The controller 21 includes a micro processing unit (MPU) 31 that controls the controller 21; a read only memory (ROM) 32; a random access memory (RAM) 33; and an input/output interface 34. The MPU 31 is also referred to as a central processing unit (CPU). The MPU 31 executes, for example, a program in the ROM 32 or the RAM 33 to provide a Web page providing function of the Web server 13A or a function of the configuration generator 13B or the character string generator 13C.

The ROM 32 stores, for example, a control program and control data for controlling the controller 21. In addition, the RAM 33 temporarily stores various programs or various types of data, and functions as a working area. The input/output interface 34 functions as an input/output interface between the respective units of the Web server 13A and the MPU 31, the respective units including the input devices such as the keyboard 22 and the mouse 23, the output devices such as the printer 24 and the display 25, and the external storage device 27.

Note that the desirable configuration that allows the Web server 13A to provide the information of the Website to the user terminals 11-1 to 11-3 may include the controller 21, the communication interface 26, and the external storage device 27. Accordingly, the input devices such as the keyboard 22 and the mouse 23 and the output devices such as the printer 24 and the display 25 may be omitted. Note that the configuration of the user terminals 11-1 to 11-3 may be the same as that of FIG. 3.

Next, an operation of the embodiment is explained. First, description is given of the case where a user or customer constructs a computer of a custom-made model via the user terminal 11-1 on the Website system 10.

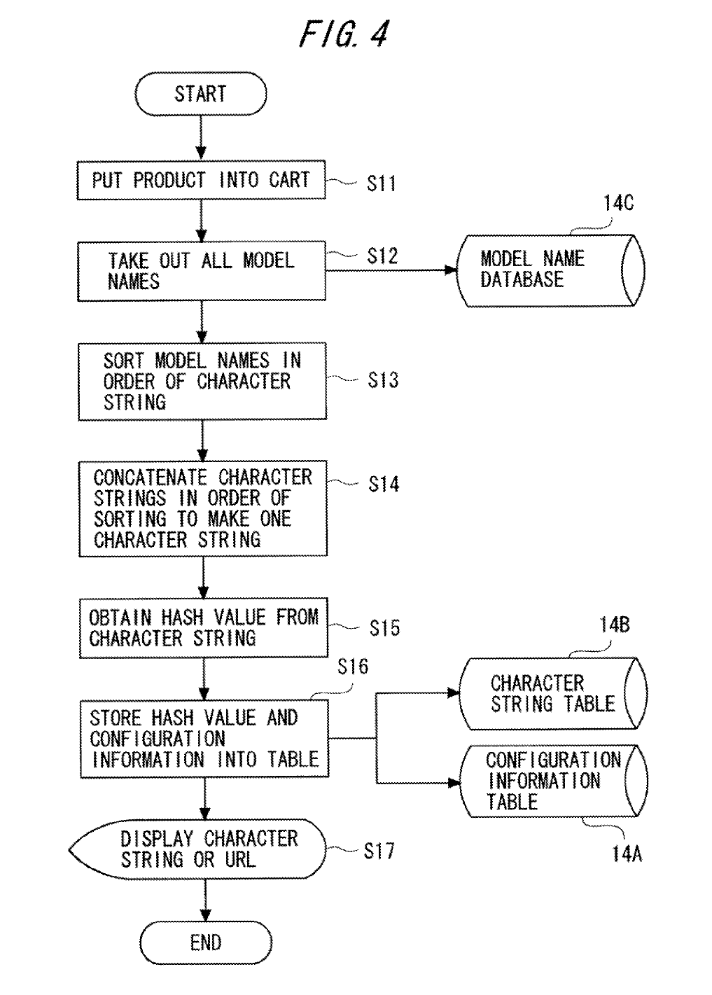

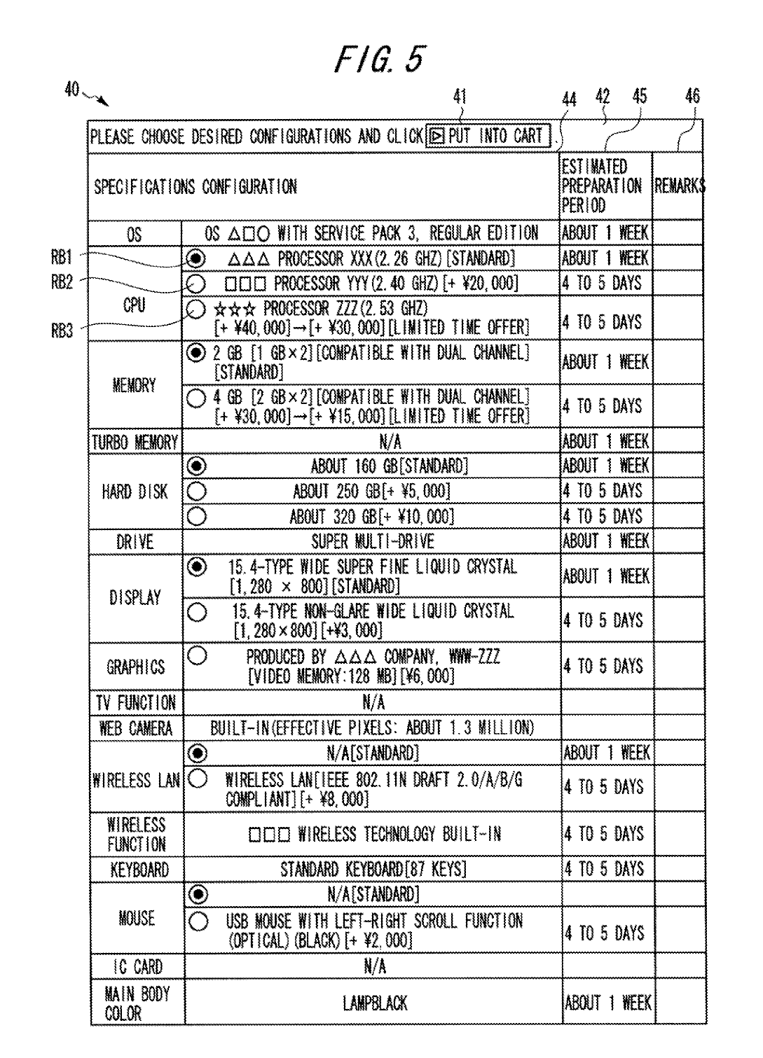

FIG. 4 is an example process flowchart for constructing the computer of the custom-made model. FIG. 5 is a schematic illustration of an example product selecting page. For example, the user accesses the Web server 13A via the user terminals 11-1 to 11-3 (hereinafter, simply referred to as a terminal), and causes the product selecting page to be displayed on a display of the terminal. The customer or user selects a constituent (also referred to as a component) of a product on the product selecting page, and puts the product into a cart after completion of the selection (Step S11). In this step, the controller 21 of the Web server 13A detects the user operation on the terminal, recognizes the component selected by the user, and holds the recognized component in a storage region of the RAM 33 corresponding to the cart. The controller 21 executes the processing in Step S11 as an example of a unit to receive designation of a plurality of information acquiring targets. The product selecting page 40 can also be regarded as an example of a unit to receive designation of a plurality of information acquiring targets.

More specifically, the product selecting page 40 includes a determination operating region 42 in which a “Put into cart” button 41 for determining a component is placed; and a configuration selecting region 43 that allows the user to select and custom-make a product configuration.

The configuration selecting region 43 includes a specifications configuring region 44 in which components that the user can select are displayed for the user to designate each component to be selected using a radio button; an estimated preparation period region 45 in which the estimated preparation period of each component is displayed; and a remarks region 46 in which various types of remarks information are to be written. As illustrated in FIG. 5, the specifications configuring region 44 includes product displaying sections for each component to be selected, and a radio button and the item name of a component configuring the product are displayed for each product displaying section. The product displaying section or the radio button of the product displaying section contains unique information (referred to as user interface (UIF) information). Accordingly, when a given radio button in the specifications configuring region 44 is selected, the controller 21 can acquire configuration information (for example, a model name) related to the component having the item name displayed in the product displaying section containing the selected radio button.

In this manner, the user clicks the radio button in the specifications configuring region 44 via the user terminal 11-1 so as to obtain a desired specifications configuration, and thus selects a desired component. In the example illustrated in FIG. 5, a radio button RB1 of three radio buttons RB1 to RB3 for the CPU is clicked to be selected.

When there are other items to be selected, configurations of the product are sequentially determined by clicking desired radio buttons. Then, after all the configurations (components) of the product are determined, the product is put into the cart with a click of the “Put into cart” button 41. After the product with the determined configurations (components) is put into the cart, the controller 21 of the Web server 13A takes the model names of the components selected on the product selecting page from the model name database 14C included in the external storage device 27 (Step S12).

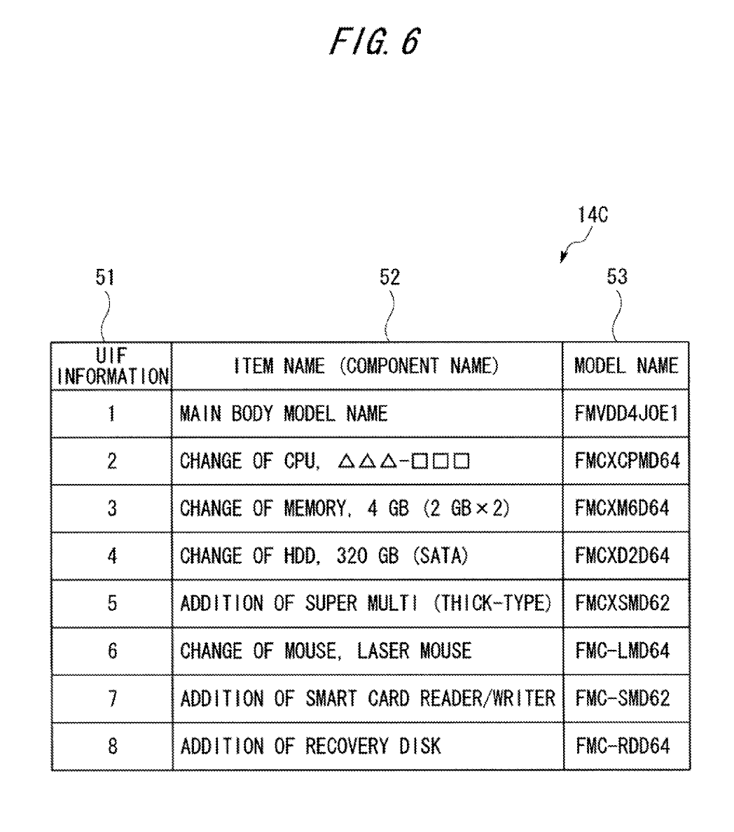

FIG. 6 is a schematic illustration of an example of the model name database 14C. A model name database 14C stores the model name of a component in association with its item name. As illustrated in FIG. 6, the model name database 14C includes a UIF information region 51 that stores UIF information; an item name region 52 that stores an item name; and a model name region 53 that stores a model name. Accordingly, for example, the UIF information is correlated with the radio button or the item name on the product selecting page 40, whereby the model name can be easily acquired. For example, the UIF information is information for uniquely discriminating the radio button or the item name displaying section next to the radio button on the product selecting page 40. Thus, when the user selects the radio button in the specifications configuring region 44 via the user terminals 11-1 to 11-3, the controller 21 of the Web server 13A can acquire the model name of the component selected by the user on the basis of the UIF information. Although numeric characters are exemplified as the UIF information in the UIF information region 51 in FIG. 6, the UIF information is not limited to numeric characters.

In addition, in the model name database 14C of FIG. 6, the UIF information region 51, the item name region 52, and the model name region 53 are illustrated. The model name database 14C may include another information region, for example, information indicating a storage location of the detailed information of each component in the product database 14D. Examples of the detailed information of each component include specifications such as the performance, dimensions, weight, color, and material of the component, the price, and picture data illustrating the appearance of the component. The controller 21 can acquire the detailed information of each component on the basis of the information indicating the storage location of the detailed information. Note that the controller 21 may hold, in a separate table, the relation between the model name of the component and the information indicating the storage location of the detailed information of each component. Alternatively, for example, the model name database 14C itself may include the detailed information of each component corresponding to the model name. In any case, for example, after the user selects his/her desired components on the product selecting page 40, the controller 21 acquires the detailed information of each of the selected components, and thus can create a Web page corresponding to the combination of the selected components.

Note that, in the processing example described in the present embodiment, the model name database 14C stores the UIF information in association with the item name and the model name, and thus the item name and the model name can be easily acquired by an operation on the radio button on the product selecting page 40. The processing of the Web server 13A is not limited to such processing using the model name database 14C. For example, the storage location on the database in which the item name, the model name, and other elements are defined may be stored together with the radio button or the item name displaying section, in a file in a Hypertext Markup Language (HTML), an Extensible Markup Language (XML), or other languages defining the product selecting page 40.

Then, the controller 21 sorts character strings of the acquired model names in the order of character code (Step S13), and concatenates the character strings in the order of sorting into one character string (Step S14). The character strings of the model names each correspond to an example of first discrimination information. Accordingly, in the case of the same components, the character string obtained by concatenating the model names of the components is always a character string in which characters are arranged in the same order.

Next, the controller 21 receives the sorted and concatenated character string as a parameter of a hash function, and obtains a character string (hash value) having a character count falling within a predetermined character count range (Step S15). In this step, for example, a Message Digest Algorithm 5 (MD5) is used as an algorithm for achieving the used hash function. Alternatively, a hash function of other type or other function (algorithm) may be used. It is desirable to generate a hash value as unique as possible from the received character string, and the hash or function value falling within the predetermined character count range.

The reason why the character count of the character string obtained as the hash value is set within the predetermined character count range is that this character string is to be used for a URL and the restriction of the length of the URL is therefore taken into consideration. The controller 21 executes the processing in Steps S13, S14, and S15 as an example of means for generating second discrimination information. In addition, the character string obtained as the hash value corresponds to an example of the second discrimination information.

Subsequently, the controller 21 stores the character string that is obtained as the hash value and has a predetermined character count, together with any unique ID into the character string table 14B. The unique ID in this case is not particularly limited as long as the ID serves as discrimination information that can be uniquely discriminated in the processing of the Web server 13A, for example, processing of providing a shopping site. For example, a serial number may be used. Alternatively, the combination of a predetermined character string and a serial number may be used. In addition, the controller 21 stores the configuration information (the model name or a code corresponding to the model name) of the component in association with the ID into the configuration information table 14A (Step S16). The character string table 14B corresponds to an example of storing means for storing a relation between the first discrimination information and the second discrimination information.

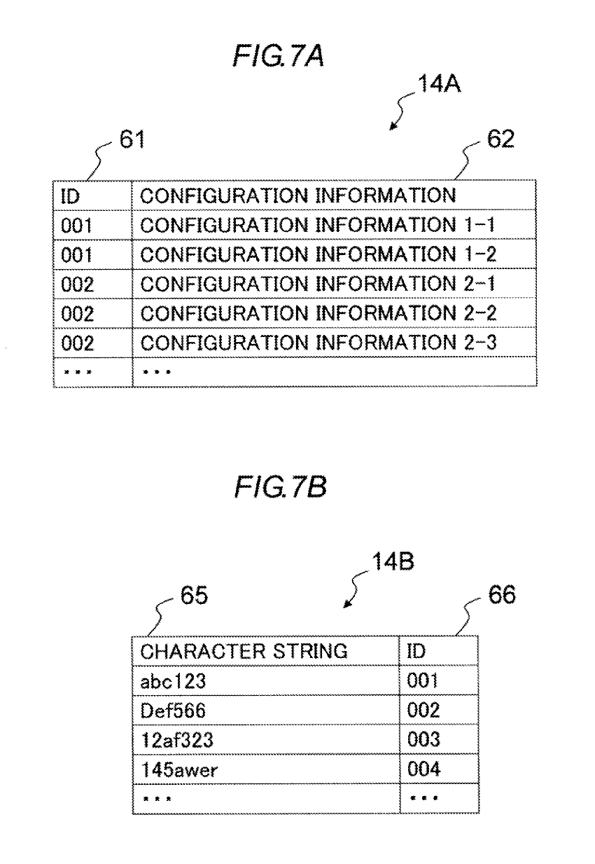

FIG. 7A is a diagram illustrating an example of the configuration information table 14A. As illustrated in FIG. 7A, the configuration information table 14A includes an ID region 61 that stores the ID given to the generated character string; and a configuration information storing region 62 that stores one or more pieces of configuration information corresponding to this ID. The number of pieces of configuration information corresponding to one ID is different depending on a product configuration, and as the number of components increases, the number of pieces of the configuration information stored in the configuration information storing region 62 increases. For example, referring to ID=[002], three pieces of configuration information 2-1 to 2-3 correspond to [002]. That is, in the example of FIG. 7A, one row (record) in the configuration information table 14A is created for a pair of ID given to the generated character string and the component which is the origin of the character string.

FIG. 7B is a diagram illustrating an example of the character string table. As illustrated in FIG. 7B, the character string table 14B includes a character string storing region 65 that stores the character string obtained in Step S15; and an ID storing region 66 that stores the ID assigned to this character string.

Note that, in the description of Step S15, FIG. 7A, and FIG. 7B, a unique ID is given to the character string obtained from the hash value to prepare for possible duplication of the character string obtained from the hash value. The processing of the Web server 13A is not limited to such processing using the ID. For example, after the processing in Step S14, the concatenated character string obtained by sorting (sorted and concatenated character string) is held without any change, and the relation with the configuration information or the relation with the character string obtained from the hash value may be defined for the sorted and concatenated character string. In the case of using the sorted and concatenated character string, the character count in a storing region of each of the configuration information table 14A and the character string table 14B will increase compared with the case of using the ID. Meanwhile, in processing of searching the configuration information table 14A for the configuration information, a decrease in processing efficiency is suppressed because the comparison proceeds from the head in the case of searching using the sorted and concatenated character string.

Subsequently, the controller 21 displays the obtained character string or URL in association with the product configuration on the user terminal 11-1 via the Internet 12, and ends the processing (Step S17). The controller 21 executes the processing in Step S17 as an example of an outputting unit.

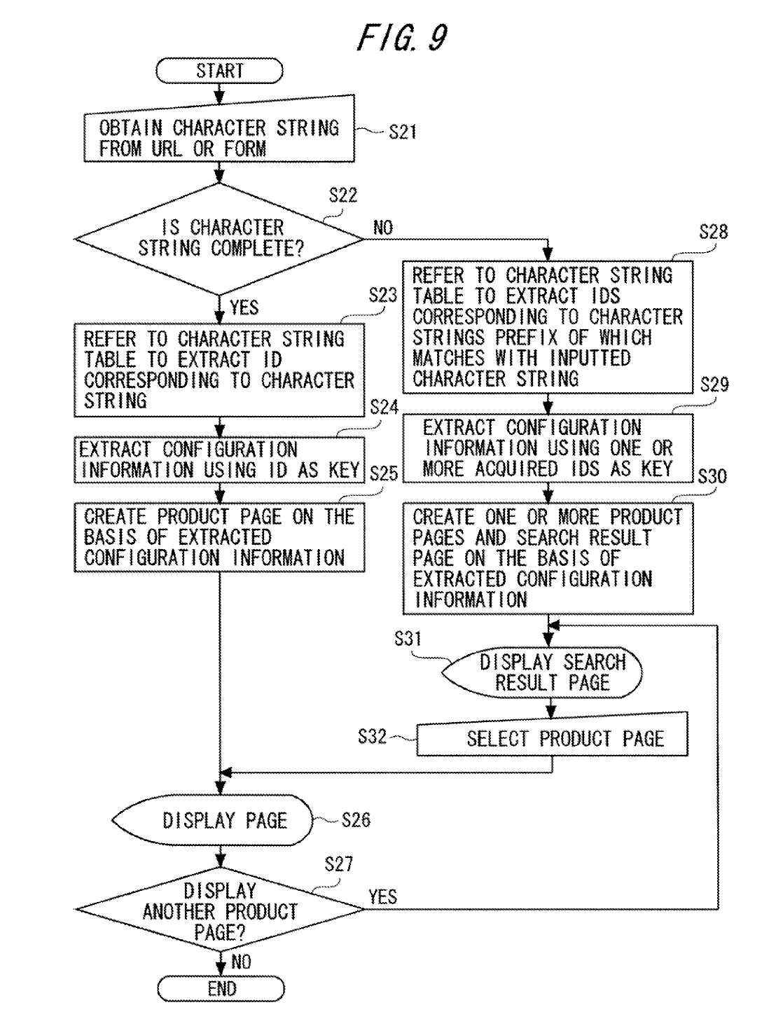

Through the processing in FIG. 4, the character string (hash value) having the character count falling within the predetermined character count range is generated in a substantially unique manner from the combination of the model names of the components selected by the user. Accordingly, with the processing in FIG. 4, a character string identifying information related to a product including the components is generated in a substantially unique manner. A substantially unique manner in this case means that when the combination of the model names of the plurality of components included in the product is different, the character string identifying the information related to the product is uniquely generated with a precision according to the performance of the hash function. Accordingly, through the processing in FIG. 4, the character string or URL is displayed to the user, whereby the user can identify the combination of the plurality of components included in the product. This character string or URL is correlated with the ID by the character string table illustrated in FIG. 7B. In addition, the ID is associated with the configuration information (for example, the model number) of the component of the product by the configuration information table 14A illustrated in FIG. 7A. Conversely, the user can use the character string or URL displayed through the processing in FIG. 4 to acquire the information related to the component of the product from the Web server 13A. Processing of acquiring the information related to the component of the product from the Web server 13A will be described later with reference to FIG. 9.

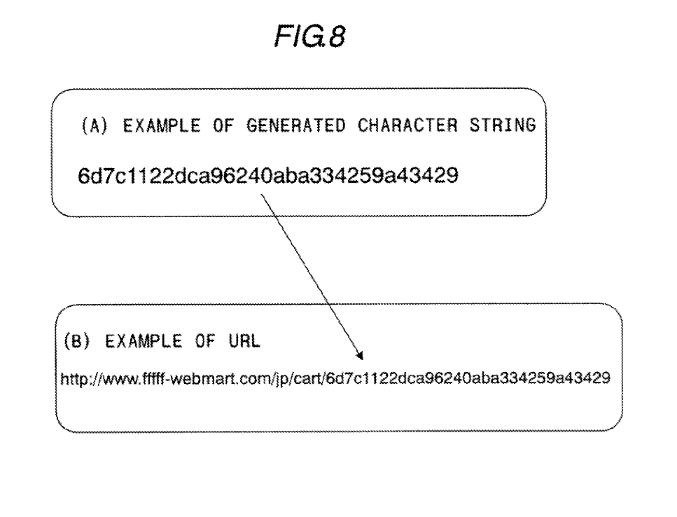

FIG. 8 is a schematic illustration of an example of the generated character string and a URL corresponding to the character string. Part (A) of FIG. 8 is an example of the generated character string, and part (B) of FIG. 8 is an example in which this character string is combined into a URL for displaying a predetermined Web page of a shopping site (www.fffff-webmart.com) corresponding to the Web server 13A.

In the case where the URL is displayed as illustrated in part (B) of FIG. 8, a schema name (http://in the above-mentioned example) +a server name and other elements (www.fffff-webmart.com/jp/ in the above-mentioned example) +a cart reader name (cart/ in the above-mentioned example) +the generated character string (hash value; 6d7c1122dca96240aba334259a43429 in the above-mentioned example) are displayed in the stated order.

Next, an operation when a Web page of a product whose configuration has been constructed is displayed on the user terminal is described. In the following description, the user terminal 11-2 is used as the user terminal.

FIG. 9 is a process flowchart for displaying the Web page of the product whose configuration has been constructed. For example, the user inputs, on a browser of the user terminal 11-2, information corresponding to the character string generated through the processing in FIG. 4, such as an URL acquired from a blog or Internet site of someone else or a URL told by someone else. Upon the input of the URL, the Web server 13A extracts the character string generated through the processing in FIG. 4, from the URL. The reason why the description is given here as the information corresponding to the character string generated through the processing in FIG. 4 is that, as illustrated in part (B) of FIG. 8, the URL is formed of the character string obtained by adding the schema name, the server name and other elements, and the cart reader name to the character string generated through the processing in FIG. 4. Accordingly, the Web server 13A may acquire the character string generated through the processing in FIG. 4 by removing the schema name, the server name and other elements, and the cart reader name, from the inputted URL.

Through such processing as described above, the character string generated from the combination of pieces of configuration information identifying the components is combined into the URL, whereby a single URL corresponding to the combination of the components can be created. Conversely, when the single URL corresponding to the combination of the components is designated, the combination of the components is identified from the designated URL, and the Web page including the combination of the components can be created.

In addition, the user may input the information corresponding to the character string generated through the processing in FIG. 4 to a predetermined form on the shopping site on the Web server 13A. The reason why the description is given here as the information corresponding to the character string generated through the processing in FIG. 4 is that there is not only a case where the character string generated through the processing in FIG. 4 is inputted to the predetermined form but also a case where part of the character string generated through the processing in FIG. 4 is inputted thereto.

As a result, the Web server 13A obtains the inputted character string via the Internet 12 (Step S21). For example, the Web server 13A acquires the character string inputted via the user terminal 11-2 from the browser on the user terminal 11-2. The controller 21 of the Web server 13A executes the processing in Step S21 as an example of a designation receiving unit.

Subsequently, the controller 21 of the Web server 13A determines whether the inputted character string is part of the character string supposed to be inputted, for identifying the Web page, that is, part of the character string generated through the processing in FIG. 4; or the complete character string generated through the processing in FIG. 4 (Step S22).

Specifically, the controller 21 of the Web server 13A determines whether the character count of the inputted character string is less than the character count of the character string stored in the character string table 14B or equal to the character count of the character string stored in the character string table 14B. When the character count of the inputted character string is more than the predetermined character count of the character string stored in the character string table, the processing is performed by prefix matching with the predetermined character count of the character string stored in the character string table, or a notice is given to the effect that the character count of the inputted character string is more than the predetermined character count, whereby reinputting is prompted. The processing of the Web server 13A is not limited, and hence the processing may be performed by prefix matching, or reinputting may be prompted.

In Step S22, when the character count of the inputted character string is equal to the character count of the character string stored in the character string table 14B, that is, when the inputted character string is complete (Step S22; Yes), the controller 21 searches the character string table 14B to acquire an ID corresponding to a character string that matches with the inputted character string (Step S23). When the appropriate character string does not exist, a notice to that effect is given, whereby reinputting is prompted. The controller 21 executes the processing in Step S23 as an example of an extraction unit to extract the first discrimination information.

Subsequently, the controller 21 refers to the configuration information table 14A to extract and acquire the configuration information corresponding to the acquired ID (Step S24). The processing in Step S24 extracts all pieces of configuration information corresponding to the acquired ID. For example, in the case where the acquired ID is “002”, in FIG. 7A, the configuration information 2-1, the configuration information 2-2, and the configuration information 2-3 are acquired. As described above, the configuration information refers to the model name of the component or the code corresponding to the model name. Accordingly, the controller 21 searches the product database 14D that stores the detailed information of the component, for example, in the external storage device 27, and thus can acquire, for example, the detailed information of the component. Examples of the detailed information of each component include specifications such as the performance, dimensions, weight, color, and material of the component, the price, and picture data showing the appearance of the component.

Subsequently, the controller 21 acquires the detailed information of the component from the product database 14D on the basis of the acquired configuration information, and creates a product page (Step S25). Then, the controller 21 provides the created product page as display data to the user terminal 11-2 via the Internet.

As a result, the product page appears on a display (not illustrated) of the user terminal 11-2 (Step S26). The controller 21 executes the processing in Steps S25 and S26 as an example of an information providing unit.

Subsequently, the controller 21 determines whether or not to display another product page (Step S27). In this case, another product page does not exist (Step S27; No), and hence the controller 21 ends the processing.

In Step S22, when the character count of the inputted character string is less than the character count of the character string stored in the character string table (Step S22; No), the controller 21 searches the character string table 14B to acquire all IDs corresponding to character strings the prefix of which matches with the inputted character string (Step S28).

Subsequently, the controller 21 refers to the configuration information table 14A to extract and acquire the configuration information corresponding to one or more acquired IDs (Step S29).

Subsequently, the controller 21 creates a product page for each ID on the basis of the acquired configuration information, and then creates a search result page on which links are put to all the product pages (Step S30). Then, the controller 21 provides the created search result page as display data to the user terminal via the Internet.

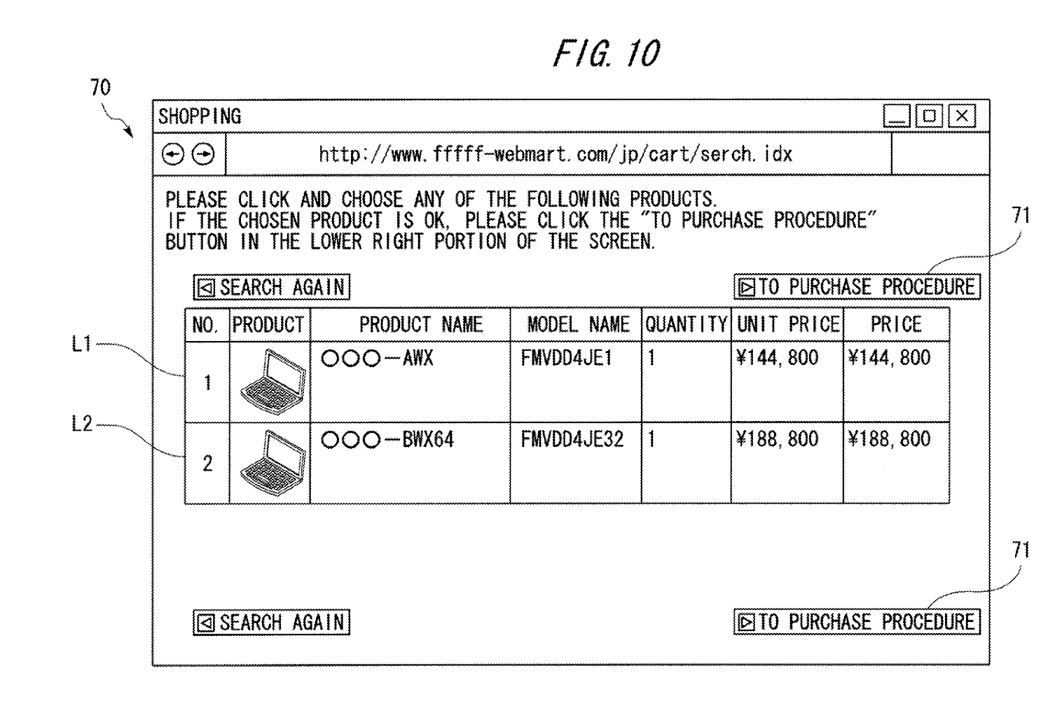

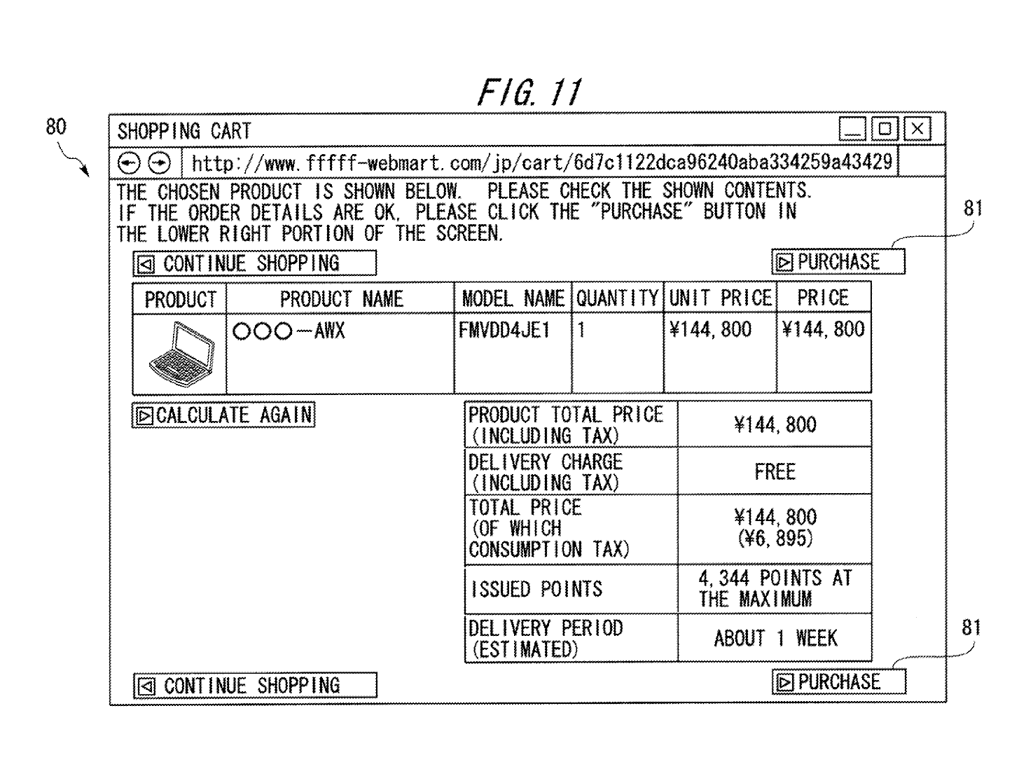

FIG. 10 is a schematic illustration of the search result page. As a result of the processing in Step S30, a search result page 70 linked to a plurality of product pages as illustrated in FIG. 10 appears on the display of the user terminal (Step S31). In this case, a number is assigned to each product page. When any of the assigned numbers is selected and inputted or a hyperlink of each product page is clicked (Step S32), the search result page 70 jumps to a page corresponding to the selected product page, and a configuration information table product page as illustrated in FIG. 11 to be described later appears on the display (Step S26). Accordingly, the user inputs part of the character string generated through the processing in FIG. 4 correspondingly to the combination of components, and thus can acquire Web pages of the plurality of corresponding products. That is, though the user does not completely designate the character string generated through the processing in FIG. 4, the user can acquire the Web pages of the corresponding products.

In this case, a link to the previous search result page is formed on each product page, and hence the user can return to the search result page as needed to browse the product page of another product. Subsequently, the controller 21 determines whether or not to display another product page (Step S27).

In this step, when the user gives an instruction to display another product page (Step S27; Yes), the controller 21 moves the processing back to Step S31, and performs the same subsequent processing.

When the user gives an instruction not to display another product page (Step S27; No), the controller 21 ends the processing.

When a character string generated through the processing in FIG. 4 is told on the telephone, for example, the following conversation is exchanged. Mr. A calls Mr. B to say, “Hello, I would like to have a personal computer with OS-N installed on it. The product I came across in a store has an application program APP that is not very necessary. As a result, the price of the product is high. I would like to have a personal computer with OS-N that does not have the application program APP.” Then, Mr. B connects his own personal computer to a shopping site, and configures a custom-made product on the basis of the contents that Mr. A told Mr. B.

After that, Mr. B says to Mr. A, “Please enter “6d7c1” on the shopping site of FFFFF Company . . . .”

Consequently, the following conversation is further exchanged. Mr. A accesses the shopping site of FFFFF Company, enters “6d7c1” to the search input box of the form on the Web page of this shopping site, and clicks the search button. As a result, as illustrated in FIG. 10, a plurality of product configurations (in FIG. 10, two product configurations) is displayed on the shopping screen 70.

At this time, Mr. A who is looking at the screen of FIG. 10 says on the telephone, “Two items appear. Of the two, which should I select? . . . ”, and Mr. B answers, “The configuration with No. 1 on the top is a personal computer I have configured for you.” Accordingly, Mr. A clicks a line L1 corresponding to No.=1.

FIG. 11 is a schematic illustration of a shopping cart screen (purchase screen). With the line L1 being selected by clicking as described above, Mr. A clicks a “To purchase procedure” button to move to a shopping cart screen (purchase screen) 80. Then, Mr. A clicks a purchase button 81, whereby the product having the product configuration that Mr. B recommends to Mr. A can be reliably purchased.

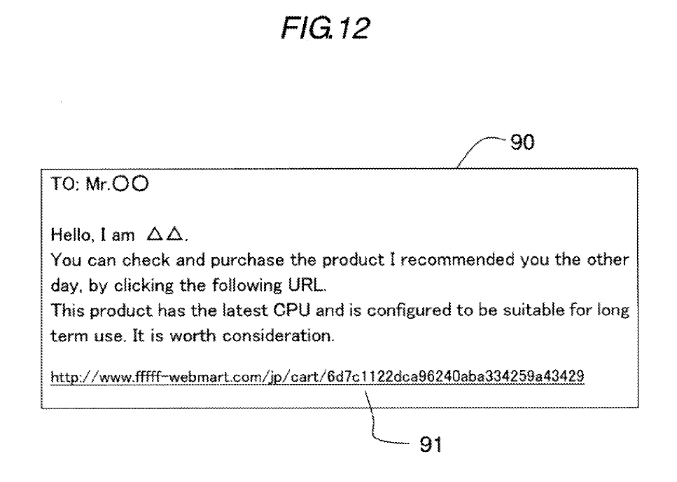

FIG. 12 is a schematic illustration of an example e-mail message for delivering a URL. When the URL is delivered by e-mail, a hypertext e-mail format is adopted for transmission, which enables an e-mail receiver to move to the shopping cart screen (purchase screen) 80 illustrated in FIG. 11 only by clicking a URL-written portion 91 of the e-mail on which a hyperlink is put. Then, the e-mail receiver can easily purchase a product by clicking the purchase button 81.

As described above, according to the present embodiment, a product configuration created by a given user can be delivered only by delivering a URL corresponding to this product configuration by e-mail or any other medium. In addition, in the case of telephone sales, a telephone salesperson selects a product that a customer seems to desire to purchase, while speaking with the customer on the telephone, and then enables the customer to check the selected product on the Web only by telling the customer a character string corresponding to a predetermined product configuration. In addition, a seller can create typical custom-made configurations (such as the lowest price configuration and the highest specifications configuration), and display the created configurations like a catalog.

In addition, a product having the same configuration is represented by the same URL. When the URL is cited on a blog, Internet site, or other media by a plurality of users, a Web page of a popular product is highly evaluated and thus can be found more easily by search engines. As a result, the URL is further cited, leading to an increase in sales of the product.

The explanation above does not include the case where the character string obtained from the hash function is identical with the character string stored in the character string table 14B. In such a case, an ID corresponding to the character string existing in the character string table 14B may be acquired, and the configuration information table 14A may be referred to on the basis of the acquired ID. Then, it may be determined whether or not the configuration of a component in the configuration information table 14A, corresponding to the character string existing in the character string table 14B matches with the configuration of a component currently selected on the product selecting page, corresponding to the character string generated afterward.

When the configuration of the component currently selected on the product selecting page is different from the existing configuration defined in the configuration information table 14A, the following processing may be performed for avoiding redundancy. That is, for example, one character of the obtained character string may be replaced with another character, and such replacing processing may be repeated until a unique character string is obtained. Then, when the character string becomes unique in the character string table 14B, the processing in Steps S16 and S17 of FIG. 4 may be executed. In the case of a hash function correctly designed, hash values barely match with each other, and hence such processing as described above can deal with a trouble satisfactorily.

The explanation above includes the processing when a so-called custom-made product is purchased by selecting components of the product. Similarly, also in processing other than the case of selecting components of a product, such as processing of creating the combination of a plurality of products, for example, a hash value may be obtained on the basis of the model names and other elements of the products, and a character string as unique as possible may be generated. In addition, a URL designating the Web page related to the combination of these products may be created. Then, when the character string or URL obtained from the hash value is designated, information related to the combination of these products, for example, a Web page including explanation of the products may be provided. Examples of the combination of the products include an assortment of food items, an assortment of liquors, a combination of clothes, a combination of ornaments, a combination of options used for layout design of a building such as a residential house, a combination of interior accessories, a combination of electronic appliances, and a combination of goods for new students/new employees.

Furthermore, the explanation above includes the case where the product is an article. In the case where a service is provided instead of the product and the service (information acquiring target) is configured by the combination of a plurality of services (constituents), the processing of the present embodiment can be similarly applied. For example, on a Web page that provides information related to various services such as a travel, a party, a golf competition, self-development, and a layout design of a residential house, elements desired by a user are selected from constituents such as a plurality of options and grades, and specifications of the service desired by the user are created. Also on such a Web page, the processing similar to the case of selecting components as in the present embodiment can be executed, and generation of a character string and creation of a Web page based on constituents (options and grades) can be executed.

In addition, not limited to a system that provides a product or service, also with regard to an information providing system that simply provides information, the similar effect can be obtained by configuring the system so as to be capable of providing a URL (address) of the same Web page for the same search result (information acquiring target) when the combination of keywords (constituents) is the same.

### <<Computer-Readable Recording Medium>>

A program that causes a computer, a machine, or an apparatus (hereinafter, the computer or the like) to implement any of the above-mentioned functions can be recorded into a recording medium readable by the computer or any other machine. Then, the computer is caused to read and execute the program in the recording medium to provide the function.

The recording medium readable by the computer herein refers to a recording medium that can accumulate information including data and programs by an electrical, magnetic, optical, mechanical, or chemical action and from which the computer can read the accumulated information. Among such recording media, a flexible disk, a magneto-optical disk, a CD-ROM, a CD-R/W, a DVD, a Blu-ray disc, a DAT, an 8-mm tape, and a memory card such as a flash memory are exemplified as media removable from the computer. In addition, a hard disk and a read only memory (ROM) are exemplified as recording media fixed to the computer.

As illustrated above, the Website system 10 can improve the convenience of transmitting information related to a plurality of information acquiring targets.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An information processing apparatus comprising:
a unit to receive designation of a plurality of information acquiring targets;
a unit to generate second discrimination information on a basis of a plurality of pieces of first discrimination information that respectively discriminate the plurality of designated information acquiring targets;
a storing unit to store a relation between the first discrimination information and the second discrimination information; and
an outputting unit to output the second discrimination information.

2. The information processing apparatus according to claim 1, further comprising:
a designation receiving unit to receive input of information corresponding to the second discrimination information;
an extraction unit to identify the second discrimination information on a basis of the information corresponding to the second discrimination information and extracting the first discrimination information from the storing unit; and
an information providing unit to provide related information related to each information acquiring target identified by the first discrimination information.

3. The information processing apparatus according to claim 2, wherein
the outputting unit generates the second discrimination information as Web page identifying information that identifies a Web page, and
the designation receiving unit receives the Web page identifying information and acquires the second discrimination information on a basis of the received Web page identifying information.

4. The information processing apparatus according to claim 2, wherein
when a plurality of pieces of the second discrimination information are identified from the information corresponding to the second discrimination information, the extraction unit extracts the first discrimination information from each of the plurality of pieces of identified second discrimination information, and
the information providing unit provides the related information for each piece of the second discrimination information.

5. A method of processing information by a computer, comprising:
receiving designation of a plurality of information acquiring targets;
generating second discrimination information on a basis of a plurality of pieces of first discrimination information that respectively discriminate the plurality of designated information acquiring targets;
storing a relation between each piece of the first discrimination information and each piece of the second discrimination information into a storing unit; and
outputting the second discrimination information.

6. The method of processing information by a computer according to claim 5, further comprising:
receiving an input of information corresponding to the second discrimination information;
extracting the first discrimination information from the storing unit on a basis of the second discrimination information; and
providing related information related to each information acquiring target identified by the first discrimination information.

7. The method of processing information according to claim 6, wherein
the computer generates, in the outputting, the second discrimination information as Web page identifying information that identifies a Web page, and
the computer receives, the Web page identifying information and acquires the second discrimination information on a basis of the received Web page identifying information.

8. The method of processing information according to claim 6, wherein
when a plurality of pieces of the second discrimination information are identified from the information corresponding to the second discrimination information, the computer extracts, the first discrimination information from each of the plurality of pieces of identified second discrimination information, and
the computer provides, the related information for each piece of the second discrimination information.

9. A storage medium storing program of instructions, on executing, the instructions causing a computer to perform:
receiving designation of a plurality of information acquiring targets;
generating second discrimination information on a basis of a plurality of pieces of first discrimination information that respectively discriminate the plurality of designated information acquiring targets;
storing a relation between each piece of the first discrimination information and each piece of the second discrimination information into a storing unit; and
outputting the second discrimination information.

10. The storage medium storing the program according to claim 9, causing the computer to further perform:
receiving an input of information corresponding to the second discrimination information;
extracting the first discrimination information from the storing unit on a basis of the second discrimination information; and
providing related information related to each information acquiring target identified by the first discrimination information.

11. The program according to claim 10, wherein
the second discrimination information is generated, in the outputting, as Web page identifying information that identifies a Web page, and
the Web page identifying information is received, and the second discrimination information is acquired on a basis of the received Web page identifying information.

12. The program according to claim 10, wherein
when a plurality of pieces of the second discrimination information are identified from the information corresponding to the second discrimination information, the first discrimination information is extracted, from each of the plurality of pieces of identified second discrimination information, and
the related information is provided, for each piece of the second discrimination information.
